(19) United States
(12) Patent Application Publication
(10) Pub. No.: US 2017/0028549 A1
(43) Pub. Date: Feb. 2, 2017

(54) ROBOTIC NAVIGATION SYSTEM AND METHOD

(71) Applicant: Comprehensive Engineering Solutions, Inc., Zionsville, IN (US)

(72) Inventor: Mark A. Battisti, Zionsville, IN (US)

(21) Appl. No.: 14/811,440

(22) Filed: Jul. 28, 2015

(51) Int. Cl. B25J 9/16

(52) U.S. Cl. CPC B25J 9/161

(57) ABSTRACT

A robotic navigation system includes a handheld navigation unit associated with a frame of reference. The handheld navigation unit is moveable with respect to a plurality of axes and is configured to send movement signals based on movement of the handheld navigation unit. A controller is configured to receive the movement signals from the handheld navigation unit and determine control signals for the robot. The control signals are configured to incrementally move the robot with respect to a point of interest removed from the robot. The point of interest is removed from a fixed point on the robot as defined by assigned coordinates. The controller is further configured to reassign the assigned coordinates following each incremental movement of the robot.

### FIELD

This document relates to the field of robotics, and particularly to robotic navigation devices configured to teach robots paths of movement.

### BACKGROUND

Robots are widely used in various forms and for various purposes. Custom gantry, multi-axis slide, and articulated robots are typical in industrial settings. Industrial robots are typically configured to move about a plurality of axes. For example a six-axis robot may be configured to move a tool held by the robot along any of three axes (i.e., position the tool at the desired X, Y, Z coordinates in space), and then orient the tool along any of three additional axes in the designated space (i.e., orient the tool with a desired roll, pitch, yaw in the space). Most robots use electric motors to move the robot's joints, slides, or linkages and place the robot in the desired position.

FIG. 1 shows an exemplary articulated robot 10 configured to move a tool about 6 axes (i.e., the X, Y, Z, roll, pitch, and yaw axes). The robot 10 includes an arm 12 with a plurality of linkages 14 and joints 16. A mounting flange 18 is provided at the distal end of the arm 12, and a tool 20 is retained by the mounting flange 18. The linkages 14 and joints 16 of the robot may be manipulated to move the mounting flange 18 at the end of the arm 12 to a desired position in 3-axis space (i.e., X, Y, Z coordinates), and then the mounting flange may be manipulated along three additional axes to provide an attitude (i.e., roll, pitch, yaw) in order to properly orient the tool 20 in space.

With continued reference to FIG. 1, various coordinate frames of reference are defined by the robot including (1) world coordinates 22, and (2) tool coordinates 24. The world coordinates 22 are defined based on the mounting location of the robot, and are therefore the robot coordinates. Accordingly, the zero of the axis of the world coordinates is the center point at the bottom of the robot mount, and the base actuator typically rotates the robot about an axis that extends through this zero point (which may also be referred to herein as the zero coordinate). The tool coordinates 24 are defined as a point at the end of the tool 20 held by the distal end of the robot arm 12. The tool coordinates 24 are a fixed location outward from the end of the mounting flange 18. When the robot 10 is moved, the control system for the robot keeps track of the position of the tool coordinates 24 relative to the world coordinates 22. Accordingly, if a user is controlling movement of the robot 10 from the world coordinates 22 frame, the control system translates movement instructions from the world coordinates 22 to the tool coordinates 24 in order to control operation of the robot. Other coordinates may also be defined based on the world coordinates 22, such as base coordinates 26 positioned on a platform 25 where a work target or other robot controller is located.

The robot controller is responsible for moving the robot 10 and any attached tool 20 to a desired point in space (X, Y, Z) with a specific attitude (roll, pitch, yaw). The robot controller is also responsible for moving the robot 10 and any attached tool 20 along a desired path. In order to make these movements, the robot controller makes calculations based on the kinematics of the robot, and determines the position required by each robot joint and linkage to arrive at each desired point in space. In order to make the desired movements at a point of interest on the robot, the robot must know is what coordinate frame we are interested in manipulating. On a typical robot, what is controlled in the standard control mode is the mounting flange at the end of the arm (which may also be referred to as the “wrist”). However, when a tool is added to the end of the arm it adds an extension to the arm (e.g., 100 mm outward from the wrist and slightly similar to that shown for the tool 20 in FIG. 1). The coordinates at the tip of the tool are the “tool coordinates”. So the robot controller may need to control movement of a straight line, arc, etc, not based on the wrist coordinates, but the tool coordinates.

FIGS. 2A-2C and 3A-3C show an exemplary articulated robot including two linkages 14a and 14b, and two joints 16a and 16b. The mounting flange 18 of the robot is holding a tool with a tool tip 21 that must be moved from point A to point B. As shown in FIGS. 2A-2C, if only a single joint 16a and single linkage 14a is moved, the motion of the tool tip 21 is along an arc 28. However, if it is desired to move the tool tip 21 in a straight line path, as shown in FIGS. 3A-3C, it is necessary for the robot controller to create a set of incremental movements for the robot such that the tool tip 21 follows the straight line path 29. With each incremental movement of the robot, both joints 16a and 16b and both linkages 14a and 14b are moved in order to place the tool tip 21 at a new target location. The robot controller then calculates a new target coordinate for the tool tip 21 along with the associated movements required by the robot to cause the robot to move the tool tip 21 to the next target coordinate. While FIGS. 2A-3C illustrate movement of the tool tip 21 along two axes, it will be appreciated that similar movements for the robot may be made along six axes.

Industrial robots often repeat the same steps over and over again in association with some industrial process. However, these robots need to be taught various positions and paths of motion prior to being regularly used for their intended purposes. For example, industrial robots and other multi-axis motion systems used in manufacturing must be taught where to move a tool tip during the manufacturing process or when and how to pick-and-place different parts. Traditional forms of teaching robotic movement include the use of a teach pendant or the use of a hand guided/back driven robot navigation.

Most robots provide some external means to receive commands, and teach pendants make use of these external means to communicate with the robot. The external interface provides a mechanism for an outside application, such as a teach pendant or other navigation device, to control the robot's motion

Teach pendants are typically handheld control boxes that allow the user to program the robot. An exemplary prior art teach pendant 30 is shown in FIG. 20. As shown in FIG. 20, the teach pendant 30 includes a numeric and alphabetic keyboard 32 and a screen 34, such as an LCD screen. The teach pendent 30 may also include other input/output devices, such as a joystick, navigation buttons, or an emergency stop 36. Unfortunately, these teach pendants are often unintuitive and intimidating to users who are unfamiliar with the unique inputs of the particular teach pendant. Teach pendants are also limited to the two frames of reference discussed above (i.e., world coordinates or tool coordinates) from which the user may program the robot. Accordingly, the ability to teach a smooth human-like path of a tool tip or other robotic movement tends to be difficult using teach pendants.

Hand guided robot navigation devices allow the user to directly steer the robot in a multitude of axis by directly pushing or pulling the robot in the desired direction. These robots with hand guided robot navigation devices typically have the ability to back drive the motors, thus allowing the robot to be shoved around. Early painting robots used this concept to directly learn paths in a “lead through the nose” style of teaching, much like a record and playback function. Drawbacks to existing hand guided navigation devices and back driven robots is that they cannot accommodate various tool coordinates, and they do not allow for intuitive remote control option.

In view of the foregoing, it would be advantageous to provide a robot navigation device that provides intuitive control of the robot, allowing the user to easily teach and control complex motion paths for purposes of robotic training and servicing. It would also be advantageous if such navigation device would allow the user to control the robot from multiple frames of reference. Additionally, once complex motion path are established by a human using a navigation device, it would be advantageous to allow for alignment, calibration and cleanup of those human generated motion paths. Therefore, it would also be desirable to provide a robotic navigation device and system with the ability to set boundaries on any hand taught motion and automatically maintain alignment to a given surface or edge.

### SUMMARY

A robotic navigation device having multiple drive points, frames of reference and coordinate systems is disclosed herein. Control options allow for isolation of work planes providing a navigation device that is intuitive for the user from any one of several different frames of reference. In addition, the robotic navigation device is configured to fit comfortably in the hand of a user and includes easy-to-use buttons for direct control of robotic devices on the robot's end of arm tooling.

In addition to an intuitive navigation device, the system disclosed herein is configured to provide additional control options that introduce external measurements to drive or maintain robot orientation and offsets. This allows for force, position, and feature tracking in conjunction with human manipulation. This allows the user to precisely control the robot's path, smoothing the path to more closely follow an intended path. As a result, the robot may be programmed with an added control dimension, such as maintaining a fixed offset distance of a tool tip from a part, or precisely following the perimeter edge of a part.

In accordance with one exemplary embodiment of the disclosure, there is provided a robotic navigation system configured to move a robot. The robotic navigation system includes a handheld navigation unit associated with a frame of reference. The handheld navigation unit is moveable with respect to a plurality of axes and is configured to send movement signals based on movement of the handheld navigation unit. A controller is configured to receive the movement signals from the handheld navigation unit and determine control signals for the robot. The control signals are configured to incrementally move the robot with respect to a point of interest removed from the robot. The point of interest is removed from a fixed point on the robot as defined by assigned coordinates. The controller is further configured to reassign the assigned coordinates following each incremental movement of the robot.

Pursuant to another exemplary embodiment of the disclosure, there is provided a robotic system comprising a robot including an arm and a mounting flange, wherein the mounting flange is moveable with respect to a point of interest. The point of interest is defined by a set of assigned coordinates relative to a point on the robot. A handheld navigation unit is positioned on the mounting member and associated with a frame of reference. The handheld navigation unit is moveable with respect to a plurality of axes and is configured to send movement signals based on movement of the handheld navigation unit. A controller is configured to receive the movement signals from the handheld navigation unit, determine a current robot location, calculate a target location for the robot, transmit robot control signals configured to move the robot, and reassign the assigned coordinates based on movement of the robot.

In accordance with yet another exemplary embodiment of the disclosure, there is provided a method of controlling a robot. The method comprises receiving movement signals from a handheld navigation unit and determining a current robot location. The method further comprises calculating a target location for the robot relative to a current point of interest, the current point of interest defined by assigned coordinates relative to a point on the robot. Robot control signals configured to move the robot are transmitted. Thereafter, the method comprises reassigning the assigned coordinates based on movement of the robot.

The above described features and advantages, as well as others, will become more readily apparent to those of ordinary skill in the art by reference to the following detailed description and accompanying drawings. While it would be desirable to provide a robotic navigation device and system that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows an articulating robot used in association with a robotic navigation device;

FIG. 2A-C shows an exemplary circular movement path of the articulating robot of FIG. 1;

FIG. 3A-C shows an exemplary linear movement path of the articulating robot of FIG. 1;

FIG. 4A shows a block diagram of a robotic navigation system and an associated robot;

FIG. 4B shows a perspective view of an exemplary embodiment of the robotic navigation system and robot of FIG. 4A;

FIG. 4C shows a front view of a tablet computer and handheld navigation unit of the robotic navigation system of FIG. 4A;

FIG. 5 shows a top perspective view of the handheld navigation unit of FIG. 4A;

FIG. 6 shows a front plan view of the handheld navigation unit of FIG. 5;

FIG. 7 shows a side plan view of the handheld navigation unit of FIG. 5;

FIG. 8 shows a bottom perspective view of the handheld navigation unit of FIG. 5;

FIGS. 9A-9F show six axis control instructions possible with the handheld navigation unit of FIG. 5;

FIG. 10 is a diagram illustrating movement of a robot receiving control signals from the robotic navigation system of FIG. 4A operating in a world coordinates mode;

FIG. 11 is a diagram illustrating movement of a robot receiving control signals from the robotic navigation system of FIG. 4A operating in a tool coordinates mode;

FIG. 12 is a diagram illustrating movement of a robot receiving control signals from the robotic navigation system of FIG. 4A operating in a fixed tool mode;

FIG. 13 shows a perspective view of the handheld navigation unit of FIG. 5 mounted on a robot arm;

FIG. 14 shows a front view of a control screen of the robotic navigation system of FIG. 4A;

FIG. 15 is a diagram illustrating movement of a robotic arm relative to a fixed tool, the robotic arm controlled with the robotic navigation system of FIG. 4A in a robot frame of reference mode;

FIG. 16 is a diagram illustrating movement of a robotic arm relative to a fixed tool, the robotic arm controlled with the robotic navigation system of FIG. 4A in a fixed tool frame of reference mode;

FIG. 17 shows a front view of a control screen of the robotic navigation system of FIG. 4A;

FIG. 18 shows a front view of yet another control screen of the robotic navigation system of FIG. 4A;

FIG. 19 is a flowchart showing steps taken by the robotic navigation system of FIG. 4A in order to move a robot; and

FIG. 20 is a prior art teaching pendant.

### DESCRIPTION

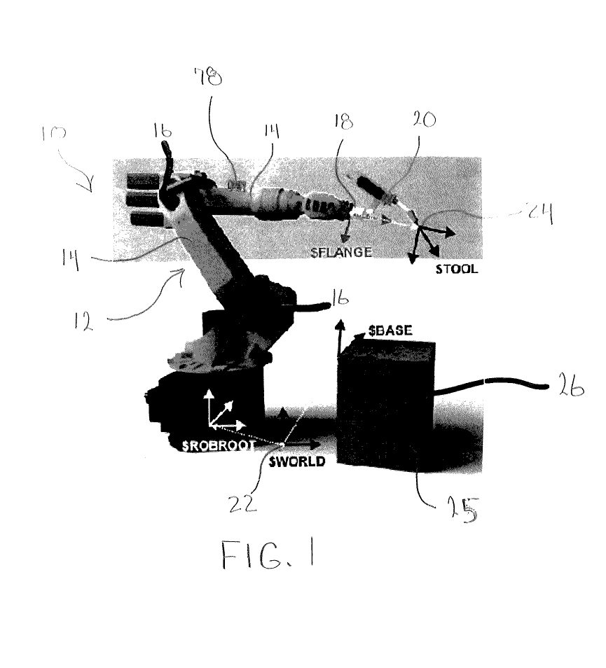

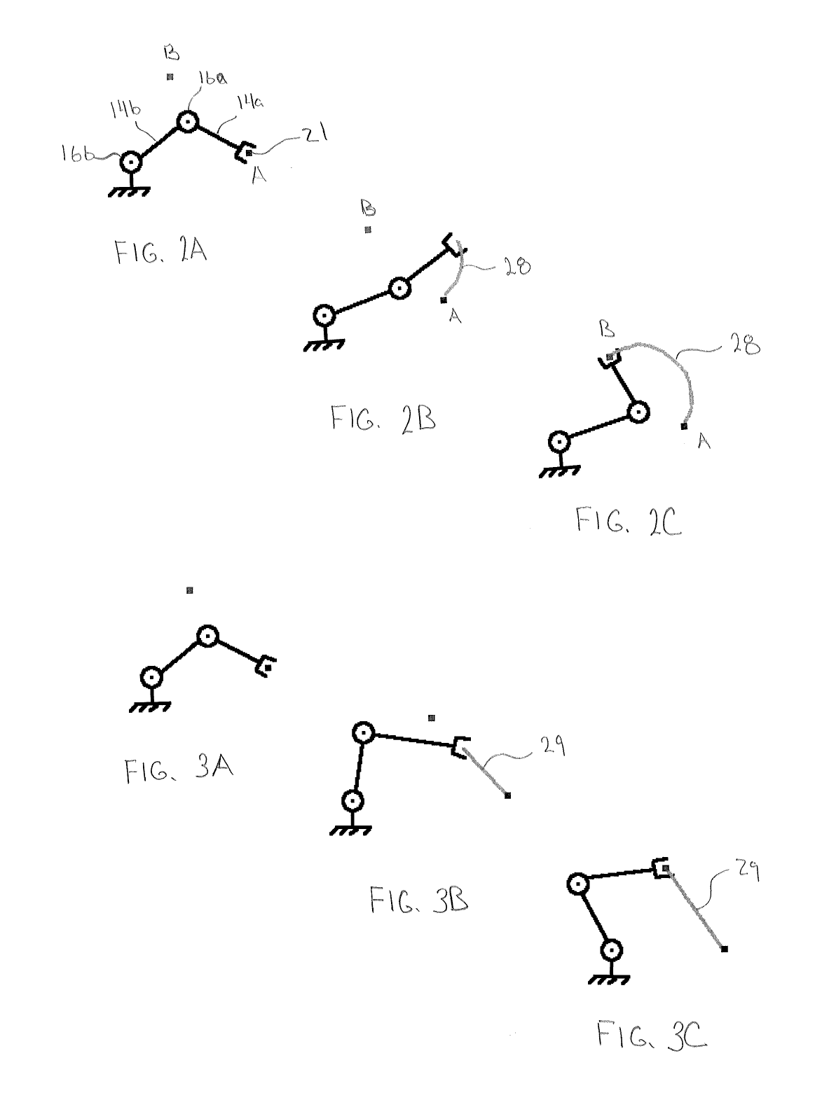

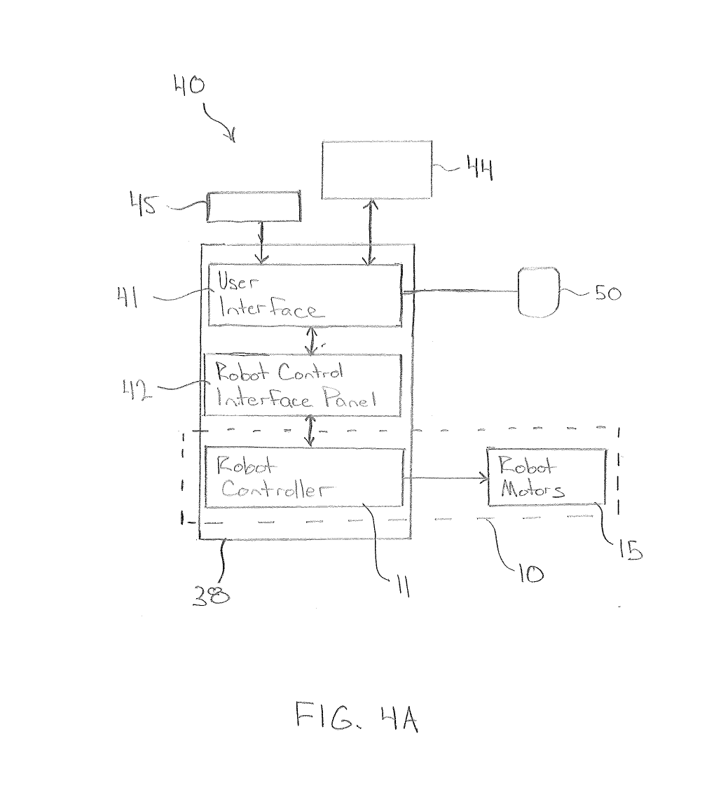

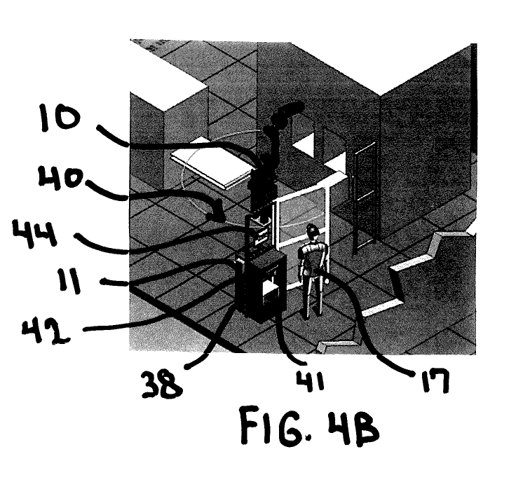

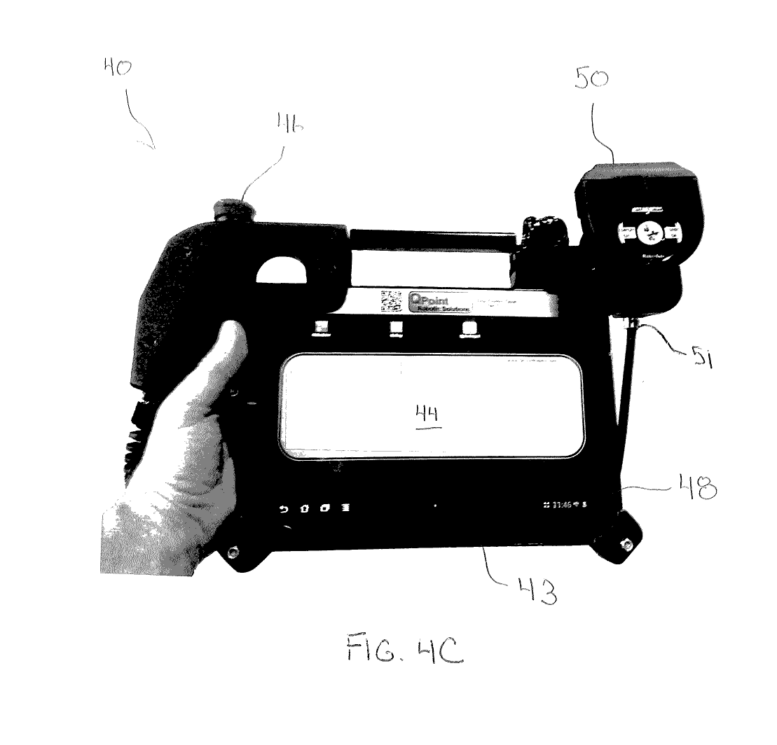

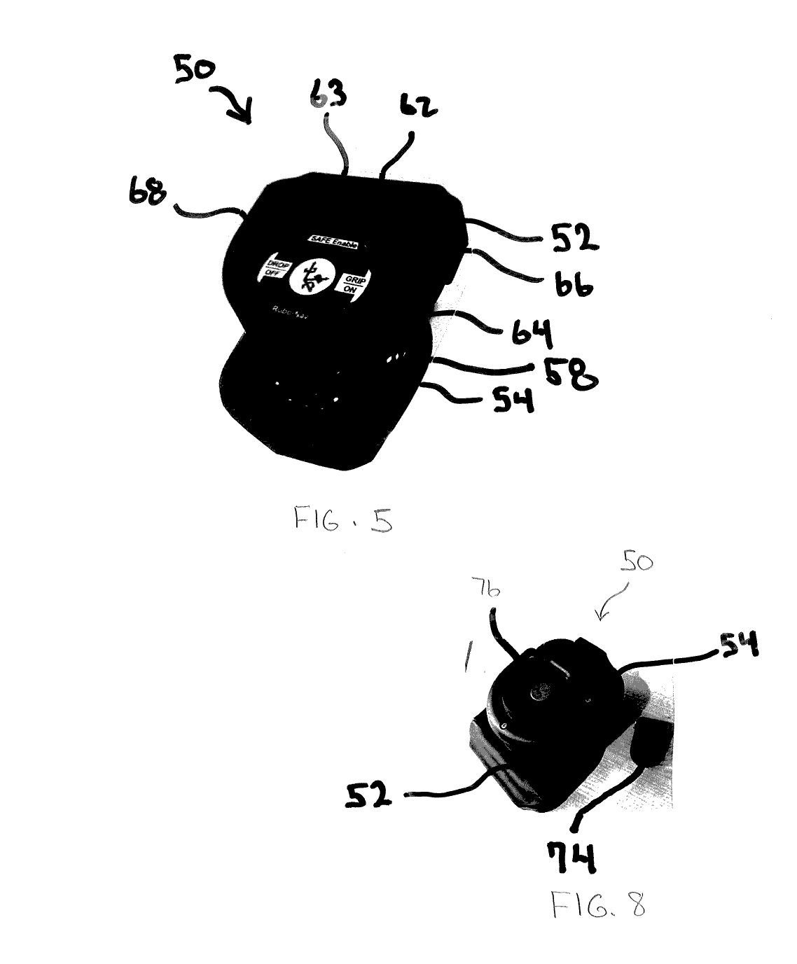

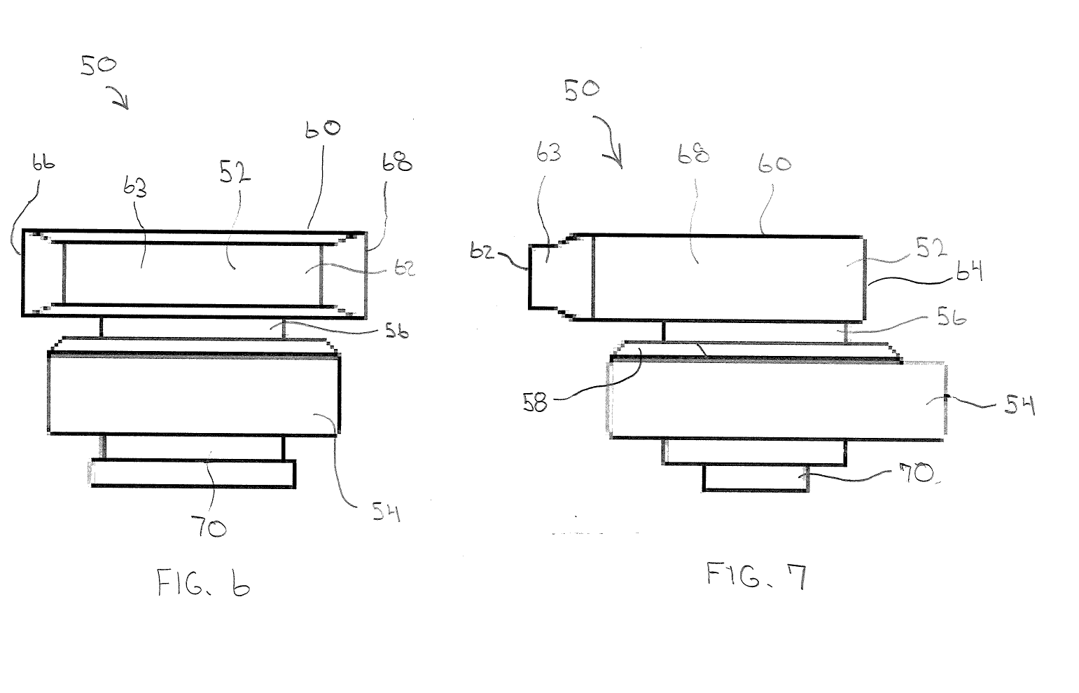

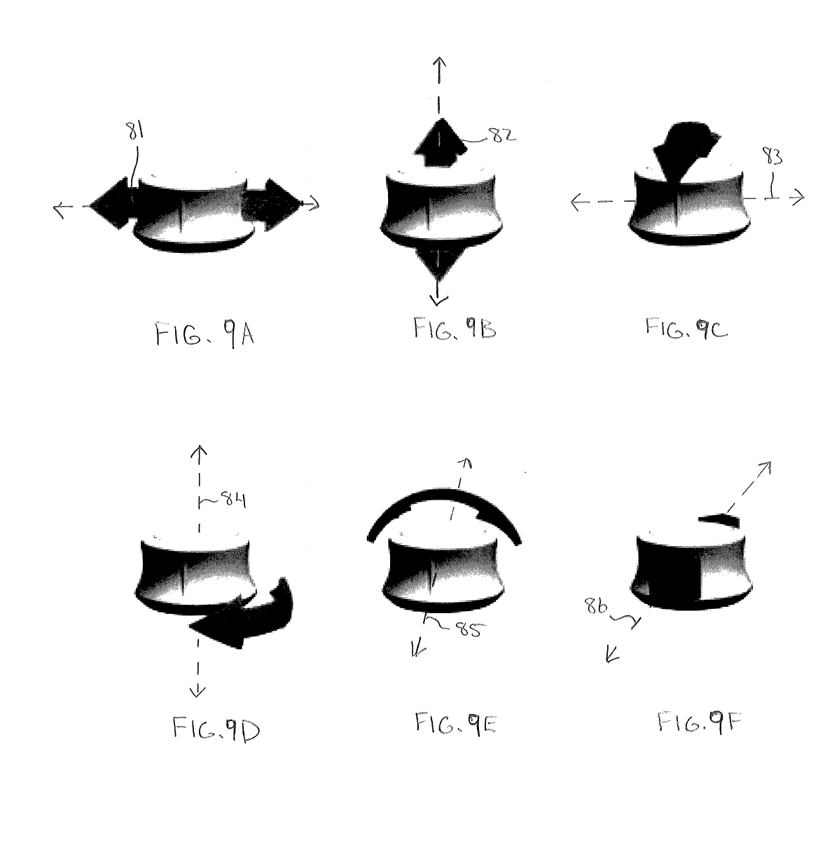

With reference to FIG. 4A, in at least one embodiment a robotic navigation system 40 includes a robot control interface panel 42, a user interface 41, and a handheld navigation unit 50. The robotic navigation system 40 is configured for use in association with a robot 10, such articulated industrial robots (e.g., see FIG. 1), gantry robots, or any of various other robots, as will be recognized by those of ordinary skill in the art. The robot 10 includes moving parts, such as an arm that is controlled by electric motors 15, and a robotic control system 11, which includes a microprocessor, memory and other electronic components. The robot control interface panel 42 is in communication with the control system 11 of the robot and provides control signals to the control system 11 of the robot in order to control movement of the robot. The handheld navigation unit 50 is in communication with the user interface 41 and the electronic control unit 42. As explained in further detail below, manipulation of the handheld navigation unit 50 by a user results in control signals being sent to the robot control interface panel 42. The robot control interface panel then translates these control signals into control signals appropriate for use by the robot. Advantageously, the robotic navigation system 40 including a handheld navigation device 50 is configured to allow control of the robot 10 by the user in any of various modes, as explained in further detail below.

Robot Control Interface Panel and User Interface

The robot control interface panel (which may also be referred to herein as the “electronic control unit”) 42 is generally a computer including a processor, memory, and various electronic components coupled to a user interface 41. In at least one embodiment, the robot control interface panel 42 may be a panel that is housed in a common housing 38 with the robot controller 11 and the user interface 41. FIG. 4B shows a human user/operator 17 next to the robotic navigation system 40, with the user interface 41, robot control interface panel 42, and robot controller 11 all housed in a common housing 38. As explained in further detail below, the robot control interface panel 42 receives instructions for robot movement from the handheld control unit 50 and performs calculations that are delivered to the robot controller 11 and result in control signals for movement of the robot 10.

The user interface 41 is in communication with the robot control interface panel 42 and provided for communications with a user of the robotic navigation system 40. The user interface 41 provides the user with various means of communicating with the robot control interface panel 42. For example, as shown in FIG. 4A, the user interface 41 may include or be associated with a number of I/O devices such as a keyboard 45, a display or touch screen 44, lights, speakers, haptic devices, or any of various other I/O devices as will be recognized by those of ordinary skill in the art. In the embodiment of FIG. 4A, the user interface 41 is also connected to the handheld navigation device 50 and transfers signals from the handheld navigation device 50 to the robot control interface panel 42. It will be appreciated that in other embodiments, the arrangement of FIG. 4A may be different. For example, the handheld navigation unit 50 may communicate directly with the robot control interface panel 42, or the various components may be differently arranged or housed from what is shown in FIG. 4A. Also, the user interface 41 may be provided in any of various forms and configurations such as a desktop computer, laptop computer, or tablet computer, and may be in communication with the robot control interface panel 42 via direct wired communications or remote wireless communications.

With reference now to FIG. 4C, in at least one embodiment the screen 44 of the user interface 41 is provided in association with a tablet computer 43. The screen 44 on the tablet computer 43 which provides the user with a remote desktop view of a stationary main computer screen (i.e., a remote screen from a screen fixed relative to the housing 38 in FIG. 4A). This tablet computer 43 generally includes a microprocessor, memory, communications modules, and a number of I/O devices, each of which will be recognized by those of ordinary skill in the art, all provided within a housing 48. The housing 48 is typically a durable housing configured to protect the electronic components therein and suitable for use in an industrial setting. The housing 48 may also include a seat 51 for the handheld navigation unit 50, allowing the handheld navigation unit 50 to be easily carried by and released from the housing 48. The seat 51 may be provided in any number of forms, such as a clip or recess in the housing 48.

In the embodiment of FIGS. 4A-4C, the I/O devices associated with the user interface 41 and the tablet computer 43 may include any of various I/O devices as will be recognized by those of ordinary skill in the art such as a screen 44, a keyboard (which may be provided as part of a touch screen), input buttons 46 or switches, a mouse or joystick (not shown), speakers (not shown), and various I/O ports (not shown). The communications modules of the robotic navigation system 40 of FIGS. 4A-4C may include circuit boards configured to facilitate wired or wireless electronic communication (e.g., over a wireless local area network). The communications modules generally facilitate communications between the various panels and devices of the robotic navigation systems including communications between two or more of the I/O devices, the handheld navigation unit 50, the user interface 41, the robot control interface panel 42, and the robot controller 11.

Handheld Navigation Device

The handheld navigation unit 50 is in electronic communication with the electronic control unit 42, and also includes at least one communication module configured to facilitate such communication. In at least one embodiment, the handheld navigation unit 50 is in wireless communication with the electronic control unit 42 and completely releasable from the housing of the electronic control unit 42 without wires or cords extending between the handheld navigation unit 50 and the electronic control unit 42.

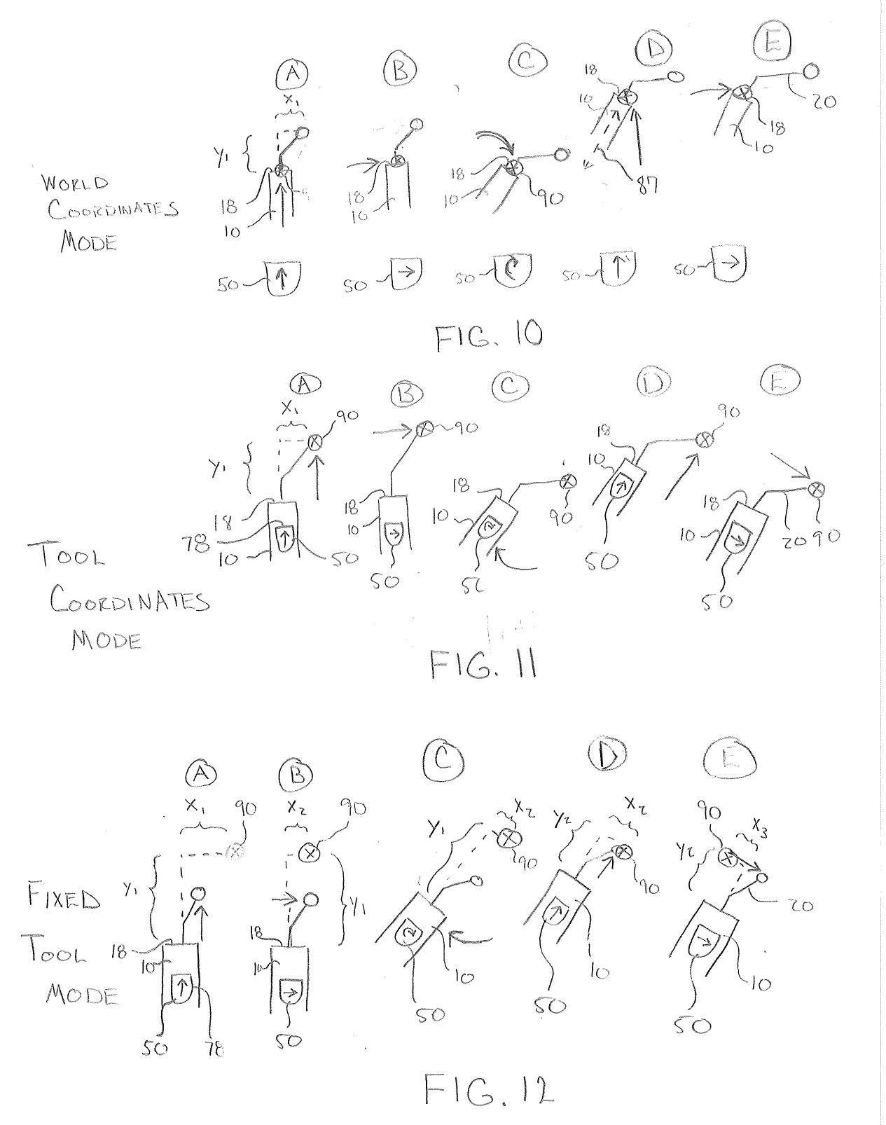

With reference now to FIGS. 5-8, the handheld navigation unit 50 includes an upper portion in the form of a knob 52 that is pivotably connected to a lower base 54 with a yoke 56 extending between the knob 52 and the base 54. The knob 52 includes a generally flat upper surface 60, a generally straight front side surface 62, an arced rear side surface 64, and two parallel lateral side surfaces 66, 68. The knob 52 is about the size of a human palm and is designed and dimensioned to fit comfortably within a human hand. Accordingly, a user may grasp the knob with his or her thumb and little finger touching the two parallel lateral side surfaces 66, 68, and the tips of the remaining fingers on or near the front side surface 62. The user's palm is designed to rest on or near the arced perimeter of the rear side surface 64. While the upper portion of the handheld navigation unit 50 has been described herein as being a knob 52, it will be recognized that the upper portion may also be provided in other forms, such as a stick (e.g., a joystick), a mouse, or any other control device configured to be grasped and manipulated by a human hand. In at least one embodiment, the knob 52 is fixedly connected to the yoke 56, such that movement of the knob results in movement of the yoke 56, and the yoke is pivotable with respect to the base (as described in further detail below with reference to FIG. 9). While the yoke 56 may be moveable with respect to the base 54, the yoke is nevertheless retained by the base such that the knob is 52 non-removable from the base 54. In other embodiments, the yoke 56 may be stationary with respect to the base, and the knob 52 may be moveable with respect to the yoke.

As described above, the knob 52 of the handheld navigation unit is pivotably connected to the base 54. The base 54 is sized and shaped similar to the knob 52, but the rear side surface of the base 54 is generally straight, while the front side surface of the base is generally arced. The base 54 may also include one or more buttons 58, which may serve as function buttons. In at least one embodiment, a button 63 is provided along the front surface 62, and this button 63 serves as an enable button for the handheld navigation unit 50. In particular, the button 63 must be depressed by the user before the robotic navigation system 40 will allow movement of the handheld navigation unit 50 to control the robot 10. Accordingly, the button 63 provides a safety feature, and is hard wired to the robot's safety circuit (via a programmed safety controller on the robot control interface panel 42).

A mount 70 is included at the bottom of the base 54. The mount 70 is configured to fit within a seat on the housing 48 of the electronic control unit 42 allowing the base 54 to be retained by the housing 48 of the electronic control unit 42. The mount also allows the base to be seated at other locations in the robot work cell, or on the robot arm. To this end, the bottom side of the mount 70 includes a cavity 72 with a releasable insert 74, as shown in FIG. 8. A magnet 76 or other mounting feature may be retained in the cavity 72. The insert 74 may be released from the cavity 72, as shown in FIG. 8, exposing the magnet 76 within the cavity 72. The cavity 72 is designed and dimensioned to engage one or more mounting features 78 (which may also be referred to herein as “mounting members”) provided on the robot. For example, in FIG. 1 an exemplary mounting feature 78 is provided on the linkage 14 of the robot 10. In at least one embodiment, each mounting feature 78 is a mounting block having a box-like structure with an outer surface that is complimentary in shape to the cavity 72 such that the mounting feature 78 fits within and fills a substantial portion of the cavity 72. The mounting feature 78 may also include a magnet that is an opposite polarity from the magnet 76 on the handheld navigation unit 50. Alternatively, the mounting feature may simply include a piece of ferrous material, such as steel, such that a magnetic attraction is established between the magnet 76 and the mounting feature 78. Because the mounting feature 78 is attracted to the magnet 76, a magnetic force is established between the mounting feature 78 and the magnet 76, and this secures the base 54 of the handheld navigation unit 50 to the mounting feature on the robot 10. Furthermore, because the magnets are releasable from one another, the handheld navigation unit 50 is releasable at each of the selected mounting locations having a mounting feature 78 fixed thereto. While the magnetic attraction between the magnet 76 and the mounting feature 78 is sufficiently strong to mount the handheld navigation unit 50 on the mounting feature 78, it should be noted that the magnetic attraction is sufficiently weak such that the handheld navigation unit 50 will break away if the human operator lurches away or if the robot quickly and the navigation unit is left behind. In these cases, no damage occurs to the unit, as there is not tearing or ripping of the mount between the handheld navigation unit 50 and the mounting feature 78. Additional functionality provided by these selected mounting locations is provided in further detail below.

Movement of the Knob of the Handheld Navigation Unit

As discussed above, the knob 52 is moveable with respect to the base 54 of the handheld navigation unit 50. In at least one embodiment, the knob 52 is configured to move about any of six axes to provide the user with the ability to control the robot and move a robot tip and an associated device (e.g., a tool) held at the robot tip to any location within reach of the robot and with any orientation of the held device. FIGS. 9A-9F illustrate this six-direction movement of the knob. While the yoke 56 is shown in FIGS. 9A-9F, it will be appreciated that the yoke may be fixedly connected to the knob 52 such that movement of the knob along any of the illustrated directions also results in movement of the yoke 56.

FIG. 9A shows that the yoke 56 may be manipulated by the user in a linear manner along an X-axis 81. Movement of the knob 52 and the attached yoke 56 along this X-axis 81 results in a control signal that causes the robot to move the robot tip along the X-axis in the direction indicated by the user along the selected reference frame's coordinate system.

FIG. 9B shows that the yoke 56 may be manipulated by the user in a linear manner along a Z-axis 82. Movement of the knob 52 and the attached yoke 56 along this Z-axis 82 results in a control signal that causes the robot to move the robot tip along the Z-axis in the direction indicated by the user along the selected reference frame's coordinate system.

FIG. 9C shows that the yoke 56 may be manipulated by the user by rotating the yoke 56 about a pitch-axis 83 (which is the same as the X-axis 81). Rotation of the knob 52 and the attached yoke 56 about this pitch-axis 83 results in a control signal that causes the robot to change the pitch of the robot tip about the pitch-axis in the direction indicated by the user along the selected reference frame's coordinate system.

FIG. 9D shows that the yoke 56 may be manipulated by the user by rotating the yoke about a yaw-axis 84 (which is the same as the Z-axis 82). Rotation of the knob 52 and the attached yoke 56 about this yaw-axis 84 results in a control signal that causes the robot to change the yaw of the robot tip about the yaw-axis in the direction indicated by the user along the selected reference frame's coordinate system.

FIG. 9E shows that the yoke 56 may be manipulated by the user by rotating the yoke about a roll-axis 85. Rotation of the knob 52 and the attached yoke 56 along this roll-axis 85 results in a control signal that causes the robot to change the roll of the robot tip about the roll-axis in the direction indicated by the user along the selected reference frame's coordinate system.

FIG. 9F shows that the yoke 56 may be manipulated by the user in a linear manner along a Y-axis (which is the same as the roll-axis 85). Movement of the knob 52 and the attached yoke 56 along this Y-axis results in a control signal that causes the robot to move the robot tip along the Y-axis in the direction indicated by the user along the selected reference frame's coordinate system.

Electronic circuitry is housed within the base 54 of the handheld navigation unit 50 and is configured to detect movement of the knob 52 (and/or the attached yoke 56) relative to the base and translate such movement into control signals. In particular, the electronic circuitry housing in the base 54 senses human pushes along the X-Y-Z axes and rotation about the roll, pitch, yaw axes. Accordingly, movement of the knob 52 results in as many as six unique control signals, and these control signals are filtered and used in calculations to deliver to the robot to control movement of the robot. In particular, these six control signals allow the user to move the robot tip and an associated device to a point in space X-Y-Z and rotate the robot tip and the associated device about the X-Y-Z axes in any direction. When six directional movement like this is provided, six motors are typically required to do this, the kinematics of the 6 motors and linkages allow positioning of the robot in 6 axis space.

Movement of the knob 52 of the handheld navigation device 50 will generally define a number of different movement components, including a direction vector component, a rotational component, and a speed component. The direction vector component will be defined based on movement of the knob 52 relative to the X-Y-Z axes (e.g., 81, 86, 82 in FIGS. 9A-9C). The rotational component will be defined based on movement of the knob 52 relative to the roll, pitch and yaw axes (e.g., 85, 83, 84 in FIGS. 9A-9C). The speed component will be defined based on the force (distance) in which the user moves the knob 52 in the desired direction. As explained in further detail below, the user may place limitations on movements of the robot 10 (e.g., exclude movement along one axis or limit the speed of movement).

It will be appreciated that while six-directional movement has been described herein, movement of the robot 10 based on movement of the knob 52 of the handheld navigation device 50 will depend on the frame of reference for the handheld navigation device 50. The robotic navigation system 50 is configured to control the robot 10 from at least three different frames of reference including (1) a world coordinate frame of reference, (2) a tool coordinate frame of reference, or (3) a fixed tool frame of reference. Accordingly, the robotic navigation system includes at least three different modes in which the robot may be controlled, including (1) the world coordinate mode, (2) the tool coordinate mode, or (3) a fixed/remote tool mode. Each of these three modes is explained in further detail below. In each of these modes, the robotic navigation system 40 is configured to control the robot 10 based on (i) a frame of reference for the handheld navigation device 50 and (ii) a point of interest relative to the mounting flange 18 of the robot 10. The point of interest is generally a point in the coordinate system wherein a target movement of the robot 10 is determined based on the point of interest. The point of interest may be, for example, a tool coordinate (i.e., a point on the tip of a tool held by the robot 10, the tool coordinate defined by a set of coordinates relative to the mounting flange of the robot). A common tool coordinate may be, for example, the tip of a paint sprayer.

World Coordinate Mode

In the world coordinate mode, the frame of reference for the handheld navigation unit 50 is fixed and the point of interest is also fixed. The frame of reference in the world coordinate mode is typically defined by the axes intersecting at the zero point of the frame of reference, which zero point is defined by the center point at the bottom of the robot mount. In this mode, the handheld navigation unit 50 is typically secured to some fixed location with the plurality of axes (see FIG. 9) for the handheld navigation unit 50 aligned with the world coordinates. With reference to FIG. 1, the handheld navigation unit 50 may be located on the platform 25, with the X-Y-Z axis for the handheld navigation unit aligned with the base coordinates 26, which are simply a translation of the world coordinates 22. The point of interest in the world coordinate mode is the mounting flange 18 of the robot 10. The navigation unit 50 can be positioned in any orthogonal direction relative to the world coordinates, and the system will use the relative coordinate frame so the motion of the robot 10 is intuitive for the user based on the orientation of the navigation unit 50.

FIG. 10 illustrates movement of the handheld navigation unit 50 and the associated movement of the robot 10 in the world coordinates mode. FIG. 10 shows five positions of the mounting flange 18 of the robot 10, with these five positions designated positions A-E. A point of interest 90 is shown in FIG. 10 for each of these positions. The point of interest 90 is the mounting flange 18. World coordinate motion can also use a tool tip location as its point of interest.

As shown by position A in FIG. 10, the handheld navigation unit 50 is removed from the robot 10 and is oriented in the world coordinates frame of reference 22. If the user moves the knob 52 of the handheld navigation device 50 in a forward direction relative to the zero point in the base coordinates frame of reference, the robot will move in a similar manner to move the desired point of interest 90 in the indicated direction. As noted previously, movement of the handheld navigation device 50 will have a direction vector component, a rotational component, and a speed component. In the example of position A of FIG. 10, the direction vector component is directly along the y-axis (see FIG. 9F), the rotational component is null, and the speed component is some magnitude (which is unimportant for the illustration of FIG. 10). In response to this movement of the handheld navigation device 50, the robotic navigation system 40 calculates a new target position and orientation for the mounting flange 18 and the associated point of interest 90 (note that because the point of interest 90 is simply a coordinate translation from the mounting flange 18, movement of the mounting flange 18 also results in the desired movement of the point of interest 90). After calculating the new target position, the robotic navigation system 40 sends control signals to the robot 10 that cause the robot to move in a manner that results in the mounting flange 18 and the associated point of interest 90 moving in the desired direction to the new target position. In the case of position A of FIG. 10, the robot 10 moves such that the point of interest 90 is moved in the forward direction in the world coordinates frame of reference. This movement of the point of interest 90 is noted by the forward arrow pointing to the point of interest 90 at position A.

As shown by position B in FIG. 10, if the user moves the knob 52 of the handheld navigation device 50 in a lateral direction (i.e., along the x-axis as shown in FIG. 9A), the robot 10 will move such that the mounting flange 18 moves in the lateral direction in the world coordinates frame of reference. This movement of the mounting flange 18 also results in the point of interest 90 moving in the lateral direction in the world coordinates frame of reference, as noted by the lateral arrow at position B.

As shown by position C in FIG. 10, if the user rotates the knob 52 of the handheld navigation device 50 in a clockwise direction (i.e., about the yaw-axis as shown in FIG. 9B), the robot 10 will move such that the mounting flange 18 moves in a clockwise direction in the world coordinates frame of reference. This movement of the mounting flange 18 also results in the point of interest 90 moving in the clockwise direction, as noted by the lateral arrow at position C.

As shown by position D in FIG. 10, after the mounting flange has been rotated in the clockwise direction, if the user moves the knob 52 of the handheld navigation device 50 in a forward direction (i.e., along the y-axis as shown in FIG. 9F), the robot 10 will move such that the mounting flange 18 moves in the forward direction in the world coordinates frame of reference. This movement of the mounting flange 18 also results in the point of interest 90 moving in the forward direction in the world coordinates frame of reference, as noted by the forward arrow at position D. It should be noted that the linkage of the robot including the mounting flange 18 is not moved forward relative its own frame of reference (i.e., the mounting flange does not move along axis 87), but instead moves in a forward direction (i.e. along the x-axis as shown in FIG. 9F) within the world coordinates frame of reference.

Finally, as shown by position E in FIG. 10, if the user moves the knob 52 of the handheld navigation device 50 in a lateral direction (i.e., along the x-axis as shown in FIG. 9A), the robot 10 will move such that the mounting flange 18 moves in the lateral direction in the world coordinates frame of reference. This movement of the mounting flange 18 also results in the point of interest 90 moving in the lateral direction in the world coordinates frame of reference, as noted by the lateral arrow at position E.

Based on the foregoing example of FIG. 10, it will be recognized that in the world coordinate mode, the frame of reference for movement of the robot 10 never changes, as it is always based on the world zero point. Accordingly, linear and rotational movements are always based on the world zero point, and the tool coordinates are not required for any target calculations. It should also be noted that the movements do not need to be singular axis. Any combination of all six axis of motion by the handheld navigation unit 50 allows for fluid six-axis motion by the robot 10. Movement of the handheld navigation unit 50 results in a six-axis vector comprised of 6 directional magnitudes which results in the motion of the robot 10 based on this six-axis vector. This is similar to flying airplane taking a corner, wherein the location and the attitude simultaneously change, in different magnitudes.

Tool Coordinate Mode

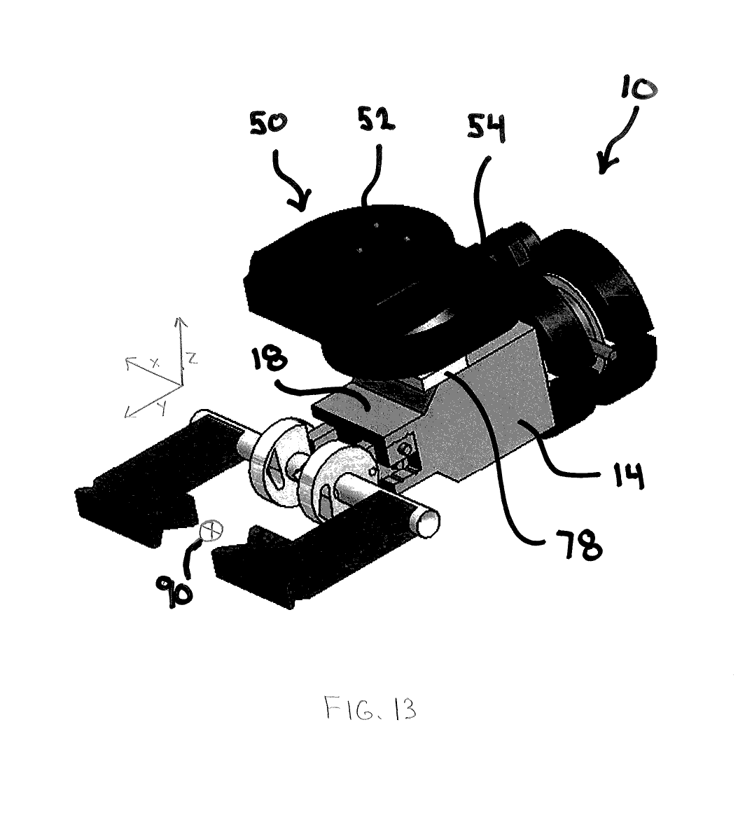

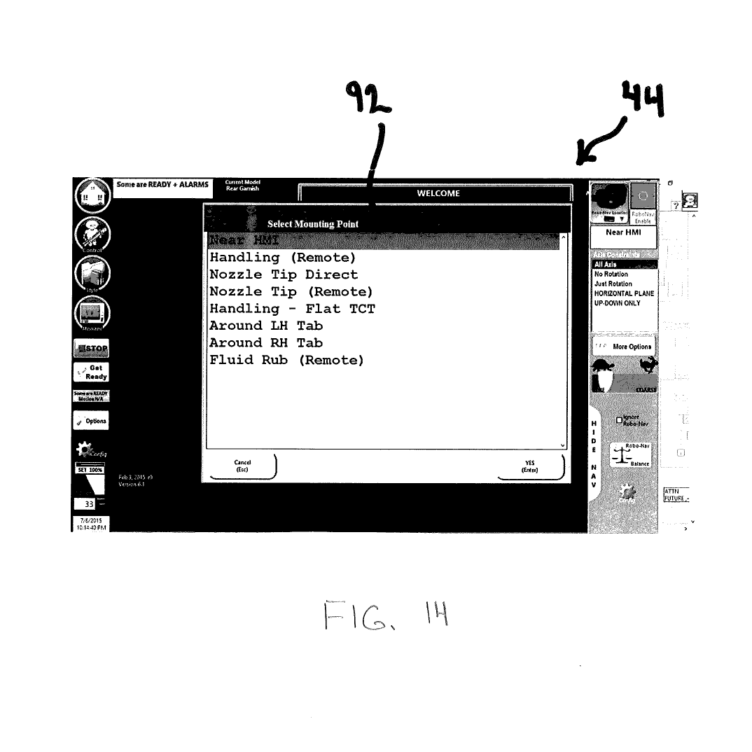

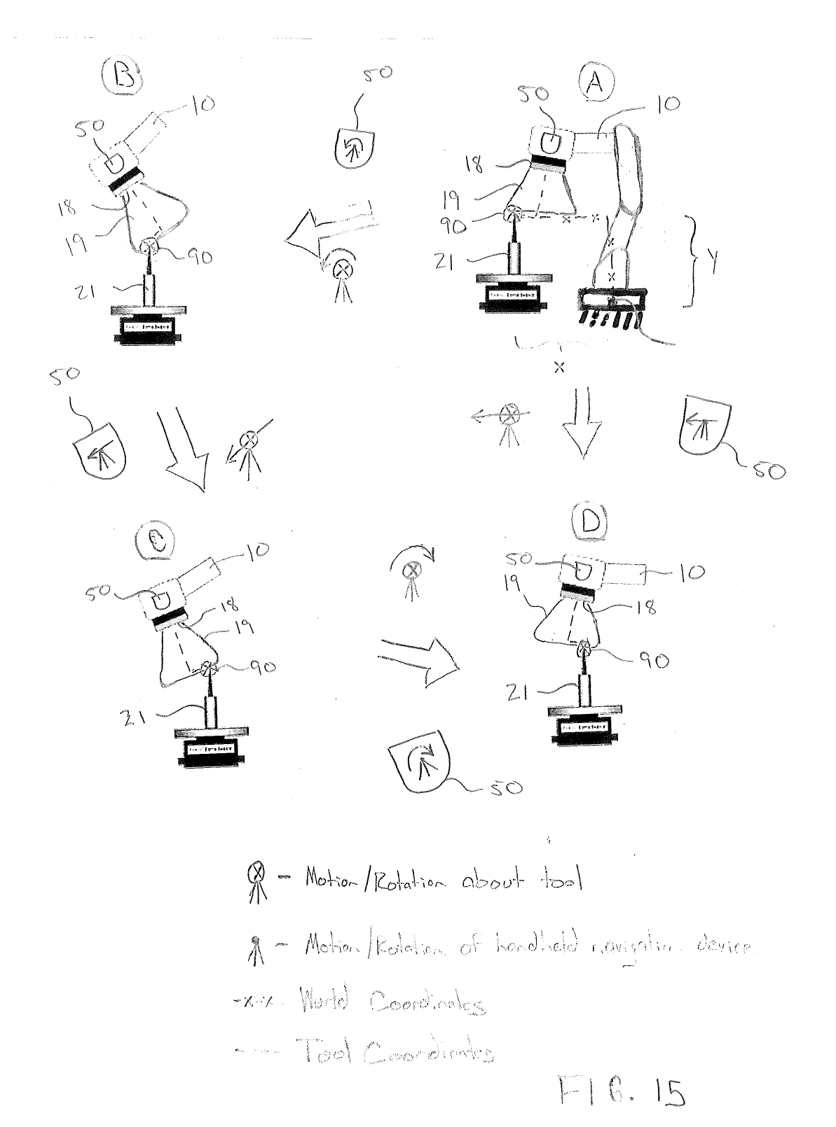

In the tool coordinate mode, the handheld navigation unit 50 is moved to one of the mounting features 78 on the robot, and the location of the mounting feature, or a position in proximity of the mounting feature becomes the frame of reference for the handheld navigation unit 50. In this mode, the frame of reference for the handheld navigation unit 50 is dynamic relative to the world coordinates 22, and the frame of reference is associated with the position of the robot 10. For example, as shown in FIG. 13, if the handheld navigation unit 50 is attached to a mounting feature 78 adjacent to the mounting flange 18 of the robot 10, the zero point for the frame of reference for the handheld navigation unit 50 may be the base of the mounting feature 78 or some fixed distance therefrom (such as a point on the tip of the mounting flange 18). In this case, the axes of the frame of reference are aligned with the portion of the linkage 14 to which the mounting feature 78 is attached (e.g., the y-axis for the frame of reference may extend along the elongated linkage 14). The frame of reference in the tool coordinates mode is referred to herein as the “tool coordinates” frame of reference. In the tool coordinates mode, the frame of reference is such that the user is provided with the feeling of riding on the robot at the location of the mounting feature 78. In at least one embodiment, the zero point (which may also be referred to herein as the zero coordinate) for the tool coordinates frame of reference is simply the mounting flange 18. In any event, the zero point for the tool coordinates frame of reference is simply a translation from the world coordinates, which frame of reference moves relative to world coordinates with each movement of the robot 10.

The point of interest 90 in the tool coordinates mode is typically the tool coordinates, which are simply a fixed translation of the coordinates of the mounting flange 18 of the robot 10. As also shown in FIG. 13, in at least one embodiment, the point of interest/tool coordinates 90 is located directly forward from the mounting flange 18. However, it will be recognized that in at least some embodiments, the point of interest in the tool coordinates mode may be another location on the robot, such as a point on the mounting flange 18.

FIG. 11 illustrates movement of the handheld navigation unit 50 and the associated movement of the robot 10 in the tool coordinates mode. FIG. 11 shows five positions of the mounting flange 18 of the robot 10, with these five positions designated positions A-E. A point of interest 90 is shown in FIG. 11 for each of these positions. The point of interest 90 is a tool coordinate, located at a fixed position relative to the mounting flange 18. The point of interest 90 is some point on a tool (e.g., a spray tip of a paint gun) or other device retained by the robot 10 which the user of the robotic navigation system 40 attempts to move in space to a desired location. In the example of FIG. 11, the tool coordinate is defined by the coordinate set (x₁, y₁). This same tool coordinate set (x₁, y₁) is constant for each of positions A-E.

As shown by position A in FIG. 11, the handheld navigation unit 50 is secured to a mounting feature 78 on the robot 10 and the frame of reference for the handheld navigation unit is the frame of reference for the mounting feature 78 (which may be, for example, the same frame of reference as the mounting flange 18). If the user moves the knob 52 of the handheld navigation device 50 in a forward direction (i.e., along the y-axis 86 in FIG. 9F) relative to the zero point of frame of reference, the robot 10 will move in a similar manner to move the desired point of interest 90 in the indicated direction within the tool coordinates frame of reference. In the case of position A of FIG. 10, the robot 10 moves such that the point of interest 90 is moved in the forward direction in the tool coordinates frame of reference. This movement of the point of interest 90 is noted by the forward arrow pointing to the point of interest 90 at position A.

As shown by position B in FIG. 11, if the user moves the knob 52 of the handheld navigation device 50 in a lateral direction (i.e., along the x-axis as shown in FIG. 9A), the robot 10 will move such that the mounting flange 18 moves in the lateral direction in the tool coordinates frame of reference. This movement of the mounting flange 18 also results in the point of interest 90 (i.e., the tool coordinates) moving in the lateral direction in the world coordinates frame of reference, as noted by the lateral arrow at position B.

As shown by position C in FIG. 11, if the user rotates the knob 52 of the handheld navigation device 50 in a clockwise direction (i.e., about the yaw-axis as shown in FIG. 9B), the robot 10 will move such that the mounting flange 18 in the clockwise direction about the point of interest 90 (i.e., the tool coordinates), as noted by the lateral arrow at position C. As shown in position C, after the mounting flange 18 has been rotated in the clockwise direction, the handheld navigation unit 50 which moves with the mounting flange has also been rotated in the clockwise direction upon the robot 10. Thus, while the frame of reference for the handheld navigation unit 50 remains the same relative to the mounting feature 78 of the robot 10 (i.e. the tool coordinate frame of reference), and while the tool coordinates remain the same (i.e., the point of interest 90 has not moved relative to the mounting flange 18), the tool coordinate frame of reference has changed relative to the world coordinate frame of reference.

As shown by position D in FIG. 11, after the point of interest 90 has been rotated in the clockwise direction, if the user moves the knob 52 of the handheld navigation device 50 in a forward direction (i.e., along the y-axis as shown in FIG. 9F), the robot 10 will move such that the mounting flange 18 moves in the forward direction in the tool coordinates frame of reference. This movement of the mounting flange 18 also results in the point of interest 90 (i.e., the tool coordinates) moving in the forward direction in the tool coordinates frame of reference, as noted by the forward arrow at position D. It should be noted that in the tool coordinate mode, direct forward movement of the handheld navigation unit 50 (i.e. movement along the x-axis as shown in FIG. 9F) only results in direct forward movement in the world coordinates frame of reference when the tool coordinate frame of reference is directly aligned with the world coordinate frame of reference.

Finally, as shown by position E in FIG. 11, if the user moves the knob 52 of the handheld navigation device 50 in a lateral direction (i.e., along the x-axis as shown in FIG. 9A), the robot 10 will move such that the mounting flange 18 and point of interest 90 (i.e., the tool coordinates) moves in the lateral direction in the tool coordinates frame of reference, as noted by the lateral arrow at position E.

Based on the foregoing example of FIG. 11, it will be recognized that in the tool coordinate mode, the frame of reference for movement of the robot 10 is aligned with and fixed to a point on the robot itself (e.g., the mounting flange 18). This frame of reference changes with each different mounting location (i.e., each location of a mounting feature 78). While this frame of reference is fixed relative to the location on the robot, the frame of reference changes with respect to the world coordinates. Movements of the robot are made to achieve the desired linear and rotational movements of the tool coordinates, and these tool coordinates are fixed in relation to the mounting flange. While each of the movements in FIG. 11 are shown as being along or about only a single axis for the sake of simplicity, it will be recognized that the handheld navigation device may be manipulated by the user to indicated simultaneous movement of the robot 10 along some portion of two or more axis (e.g., all six axes). In this mode, movement of the robot 10 is determined by forming a six-axis vector based on movement of the navigation device 50, where the movement of the navigation device 50 relative to each of six axes is translated into a movement vector for the robot with movement along each axis being simultaneous and with independent/different magnitudes.

The ability to mount the handheld navigation unit 50 in any of multiple locations on the robot 10 based on the locations of the various mounting features 78 makes the tool coordinates mode more intuitive and easy to learn for a user. While FIGS. 1 and 13 show two possible locations for the mounting feature 78 on the robot 10, it will be appreciated, that numerous other locations are also possible. Each time the handheld navigation unit is placed in a new location, a new frame of reference for the 6-axis feedback is established, and as explained above, this new frame of reference is used to translate a movement request into the desired motion of the robot 10. Accordingly, before a movement request from the handheld navigation unit may be processed, the robotic navigation system 40 must determine the frame of reference for the handheld navigation unit 50. Thus, the electronic control unit 42 associates each of the mounting features 78 with a mounting location and each mounting location with its own frame of reference. The location where the handheld navigation unit 50 is mounted may be determined automatically by the robotic navigation system, or may need to be specified by the user.

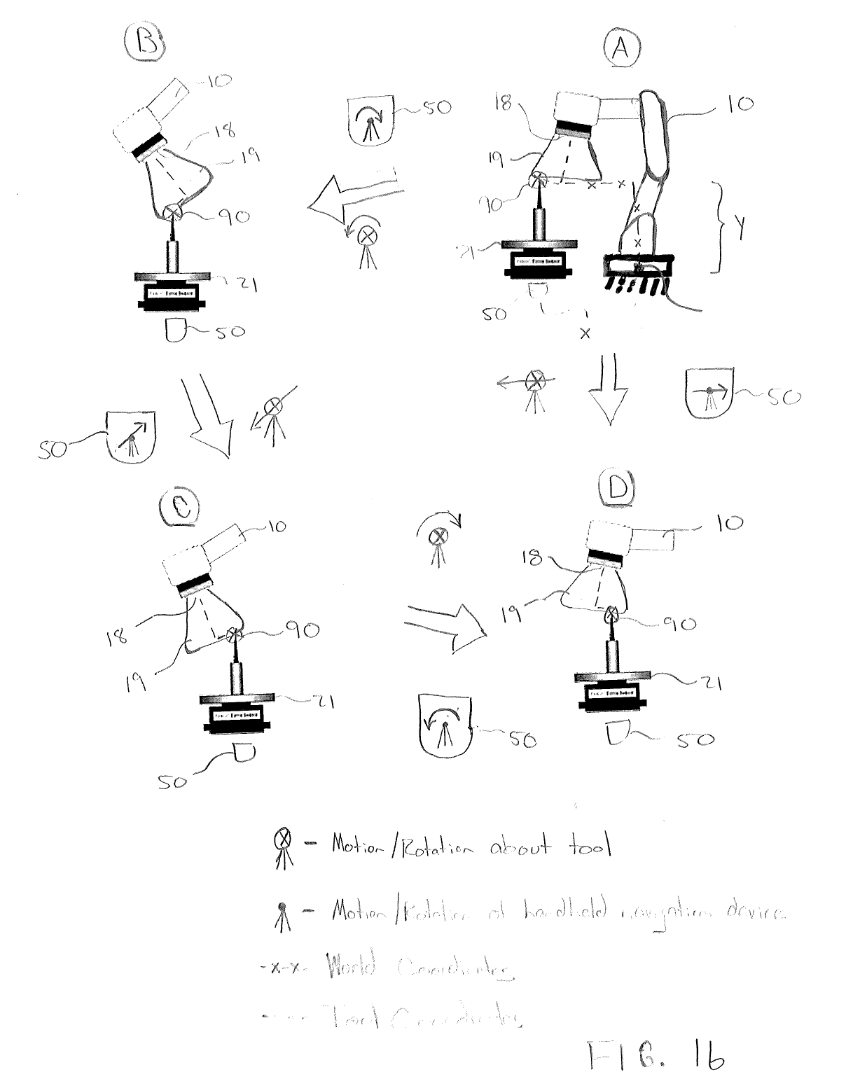

In at least one embodiment, the mounting features 78 have no identifier. In this embodiment, the user indicates to the electronic control unit 42 which mounting feature the handheld navigation device is mounted upon, and therefore, which reference frame of reference to use. FIG. 14 shows an exemplary screen shot of the screen 44 providing a menu 92 to the user. The menu 92 includes a list of eight different mounting points where a mounting feature is located. When the user selects one of these mounting points on the screen 44, the electronic control unit 42 uses the frame of reference associated with that mounting point when translating movement requests from the handheld navigation unit 50 into the desired motion of the robot 10.

In at least one alternative embodiment each mounting feature 78 includes a code or other identifier that may be read by the handheld navigation unit 50 and automatically sent to the electronic control unit 42 when the handheld navigation unit 50 is mounted on the mounting feature 78, thus informing the electronic control unit 42 of the location and frame of reference for signals sent from the handheld navigation unit 50. In at least one embodiment, the identifier is an RFID tag located at each mounting feature 78. In another alternative embodiment, the identifier is a resistor having a unique resistance, wherein the resistor is connected to a circuit in the handheld navigation unit 50 when the handheld navigation unit is placed on the mounting feature 78. In yet additional exemplary embodiments, the identifier may include image sensing devices such as a QR code (3D barcode), bar code (2D barcode), or binary sensor matrix.

Fixed/Remote Tool Mode

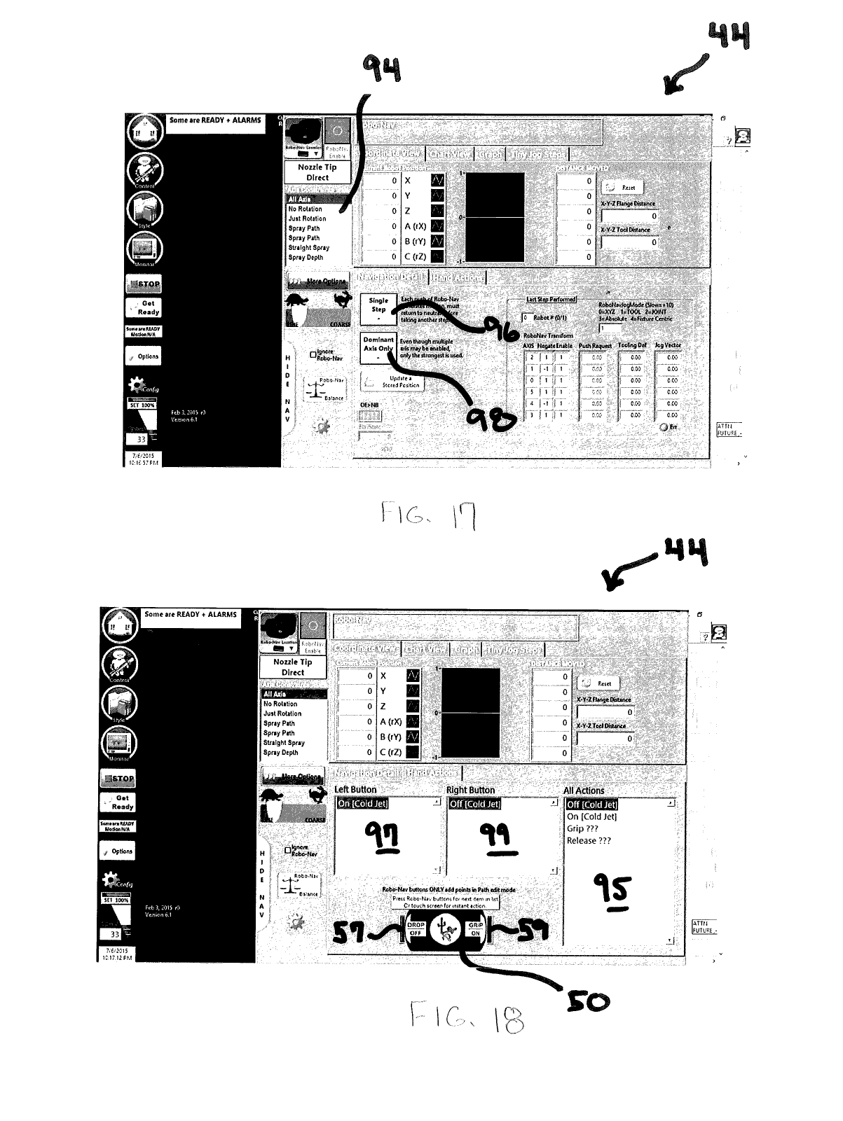

In the fixed/remote coordinate mode, the handheld navigation unit 50 may be either connected to one of the mounting features 78 on the robot or mounted remote from the robot. Accordingly, the fixed/remote mode includes two sub-modes, including a first sub-mode where the handheld navigation unit is mounted on one of the mounting features 78 of the robot 10, and a second sub-mode where the handheld navigation unit is mounted remote from the robot. Exemplary operation of the robot 10 in the first sub-mode is described with reference to FIGS. 12 and 15. Exemplary operation of the robot in the second sub-mode is described with reference to FIG. 16.

With reference now to FIG. 12, in the remote tool mode, the frame of reference for the handheld navigation unit 50 is a mounting feature 78 on the robot 10. The point of interest 90 in the remote tool mode is a point on a remote tool that is completely removed from the robot 90. The remote tool is typically a stationary tool having a fixed location relative to the robot 10. However, unlike the world coordinates mode and the tool coordinates mode, in the remote tool mode, the point of interest 90 is actually moveable relative to the robot.

FIG. 12 illustrates movement of the handheld navigation unit 50 and the associated movement of the robot 10 in the remote tool mode. FIG. 12 shows five positions of the mounting flange 18 of the robot 10, with these five positions designated positions A-E. A point of interest 90 is shown in FIG. 12 for each of these positions. The point of interest 90 is a fixed position on a stationary tool that is separate from the robot. The point of interest 90 may be some point on a rotary tool (e.g., a de-burring shaft), spray tool, or any of various other tools. In the example of FIG. 12, the point of interest is removed from the mounting flange (zero point) by a distance defined by the coordinate set (x₁, y₁). However, as will be explained in further detail below, this point of interest coordinate set (x₁, y₁) is different with each movement of the robot along positions A-E.

As shown by position A in FIG. 12, the handheld navigation unit 50 is secured to a mounting feature 78 on the robot 10 and the frame of reference for the handheld navigation unit is the frame of reference for the mounting flange 18. If the user moves the knob 52 of the handheld navigation device 50 in a forward direction (i.e., along the y-axis 86 in FIG. 9F) relative to the zero point of the frame of reference, the robot 10 will move in a similar manner to move the mounting flange 18 in the indicated direction as indicated by the arrow in the position A diagram. However, when the mounting flange 18 moves, the point of interest 90 remains stationary in the remote tool mode. Thus, movement of the mounting flange 18 results in a change in the distance between the mounting flange 18 and the point of interest 90, which changes the assigned coordinates for the point of interest relative to the robot flange. For example, in position A, the assigned coordinates are shown as (x₁, y₁), while in position B, the assigned coordinates are (x₂, y₁).

Position B of FIG. 12 shows that, if the user moves the knob 52 of the handheld navigation device 50 in a lateral direction (i.e., along the x-axis as shown in FIG. 9A), the robot 10 will move such that the mounting flange 18 moves in the lateral direction toward the point of interest 90 (i.e., x₁>x₂), as noted by the lateral arrow at position B. Thus, because the mounting flange 18 is closer to the point of interest 90 new coordinates are assigned to the point of interest following the movement to position B.

As shown by position C in FIG. 12, if the user rotates the knob 52 of the handheld navigation device 50 in a clockwise direction (i.e., about the yaw-axis as shown in FIG. 9B), the robot 10 will move the mounting flange 18 in the clockwise direction, rotating about the point of interest 90. This rotational movement of the robot 10 relative to the point of interest 90 does not change the assigned x-y-z coordinates (only x and y coordinates are shown in FIG. 12 for the sake of simplicity, and the assigned coordinates remain (x₂, y₁) of the robot flange relative to the point of interest following the movement of position C. However, it will be recognized that attitude coordinates (i.e., roll, pitch, yaw) will change with rotational movement of the handheld navigation device 50 and the associated rotational movement of the robot 10.

As shown by position D in FIG. 12, after the mounting flange 18 has been rotated in the clockwise direction about the point of interest 90, if the user moves the knob 52 of the handheld navigation device 50 in a forward direction (i.e., along the y-axis as shown in FIG. 9F), the robot 10 will move such that the mounting flange 18 moves in the forward direction toward the point of interest 90, as noted by the arrow at position D. This movement of the mounting flange 18 results in the assigned coordinates for the point of interest 90 moving once again. In particular, the newly assigned coordinates for the point of interest become (x₂, y₂), with y2<y₁. In this position D, the resulting coordinates for the tip of the tool 20 connected to the mounting flange 18 are nearly the same as the coordinates for the point of interest 90.

Finally, as shown by position E in FIG. 12, if the user moves the knob 52 of the handheld navigation device 50 in a lateral direction (i.e., along the x-axis as shown in FIG. 9A), the robot 10 will move such that the mounting flange 18 moves in the lateral direction away from the point of interest 90, resulting in a new set of coordinates for the point of interest (i.e., (x₃, y₂)). In this case x₃ is actually an opposite value from x₁, as the mounting flange was to the left of the point of interest with x₁ and the mounting flange is to the right of the point of interest with x₃.

As shown from the example of FIG. 12, in the remote tool mode, manipulation of the robot is made with respect to a point in space that is remote from the robot (e.g., consider rotation about the point of interest 90 in position C of FIG. 12). Each time the robot moves a predetermined incremental amount (as defined by the system), the robot's frame of reference, distance and attitude from the point of interest on the remote tool shifts. Accordingly, each small move by the robot then requires a new re-calculation of the reference frame. This reference frame may be defined by a straight line from the tip of the remote mounted tool (e.g., a spinning drill bit) to the center of the mounting flange of the robot. As discussed above coordinates for the point of interest can be provided to define this vector defining the reference frame. Each time the robot moves, the angle, and or distance of this vector changes. In this version of remote fixed tool where the navigation device is fixed to the robot, the movement is quite similar to tool coordinate mode for translation, but for rotation, the motion is unique, in that the point of rotation is fixed in space, not fixed relative to the robot flange.

The above-described unique frame of reference for movement of the robot provides several advantages for the user. First, the remote tool mode allows the user to manipulate the robot in a manner that makes the user feel as if he is manipulating about the fixed tool. Second, this remote tool mode allows the user to more intuitively use a tool while a part is held by the robot instead of a fixed part and robot held tool. Third, because the user has the advantage of a more intuitive manipulation of the robot with respect to a remote tool, manufacturing steps may be omitted. In particular, there is no need to have a first robot release a part, hold the part stationary, and then have a second robot move a tool relative to the stationary part. Instead, a robot that grabs a part may retain the part and simply move the part relative to a stationary tool. This action is uncommon in many industrial manufacturing environments. An example of the advantageous frame of reference provided by the remote tool mode is described now in further detail with respect to FIGS. 15 and 16.

FIG. 15 shows an exemplary arrangement utilizing the first sub-mode for the remote tool mode. In this arrangement, the handheld navigation device 50 is positioned on a mounting feature of the robot 10 near the mounting flange 18, as shown at position A. As shown in FIG. 15, the robot 10 is holding a manufacturing part 19 in proximity to a stationary tool 21. The point of interest 90 is a tip of the stationary tool. As shown in the movements from position A-D of FIG. 15, rotation of the handheld navigation device 50 results in movement of the robot such that the part pivots about the point of interest 90. For example, in moving from position A to position B, the user rotates the knob of the handheld navigation device in a counter-clockwise direction. This results in the robot moving the mounting flange 18 such that the part 19 contacts the stationary tool 21 at the same location on the part 19, but the part 19 is pivoted about the point of interest 90. It will be recognized that this pivoting results in no change of the robot's mounting flange 18 x-y-z coordinates relative to the point of interest (which coordinates are noted to as the “tool coordinates” in the illustration of FIG. 15, described in further detail below). The resultant motion is much like tool coordinate rotation in FIG. 11-C, but the point of interest is used to mathematically generate the tool coordinate. It will also be recognized that this pivoting does result in a change in the attitude coordinates (i.e., roll, pitch, yaw) for the point of interest.

While rotation of the knob of the handheld navigation unit 50 does not change the assigned tool coordinates in the movement from position A to position B, the assigned tool coordinates do change when the handheld navigation unit 50 is moved in a linear direction. For example, as shown in the movement from position B to position C, movement of the handheld navigation unit in a lateral direction results in the point of interest 90 moving from one side of the part 19 to an opposite side of the part. Accordingly, the x-coordinate for the point of interest 90 has an opposite value in position C than in position B, since the point of interest is now on an opposite side of the mounting flange zero location. The movement illustrated from position A to position D shows a similar change in the tool coordinates when linear motion is requested by movement of the handheld navigation device 50.

The movement from position C to position D again illustrates the frame of reference for rotational movement of the robot in the remote tool mode. In particular, rotational movement of the handheld navigation device 50 results in movement of the robot 10 such that the part 19 pivots relative to the point of interest 90, but the part remains in contact with the stationary tool 21 at the same location. In this case, clockwise movement of the handheld navigation device results in clockwise rotation of the part 19 with rotation centered about the point of interest. Again, the rotational movement does not result in a change of the tool coordinates.

With reference now to FIG. 16, an exemplary arrangement illustrating the second sub-mode for the remote tool mode is shown. In this arrangement, the handheld navigation device 50 is positioned at a fixed location near the remote tool 21 (e.g., at the base of the fixed tool). In this mode, the frame of reference allows the user to feel as if he is actually moving the stationary remote tool 21, even though the remote tool is fixed in place. It will be recognized that the movement of the robot in FIG. 16 from positions A-D are identical to the movements described above in FIG. 15. Also, identical to FIG. 15, rotational movements of the handheld navigation unit 50 in FIG. 16 do not change the tool coordinates for the remote point of interest 90 but linear movements of the handheld navigation device 50 do change the tool coordinates. As a result the tool coordinates are updated/reassigned with each linear movement of the handheld navigation device. However, FIG. 16 is different from FIG. 15 in that movements of the handheld navigation unit 50 in FIG. 16 are directly opposite those shown in FIG. 15, even though movement of the robot from position-to-position is the same. Accordingly, in this mode, the user moves the handheld navigation unit in the direction he or she desires to move the point of interest 90, and the robot makes the appropriate movements to provide the user with the perspective that he or she is actually moving the fixed point of interest 90. For example, in movement from position B to position C in FIG. 16, the user moves the handheld navigation device in a linear motion that is at an upward and rightward angle of approximately 45°. As a result, the position of the point of interest 90 moves along the part 19 at an upward and rightward angle of approximately 45°. Again, this gives the user the feeling that he or she is moving the remote tool even though the tool is stationary. This gives the user a more intuitive feel for controlling a robot that is holding a part to be manipulated by a remote tool.

Other Inputs for Handheld Navigation Device

Various frames of reference, mounting locations and movements for the handheld navigation unit 50 have been described above. It will also be appreciated that additional controls for the handheld navigation device may be provided on both the unit 50 and in the electronic control unit 42 (e.g., provided on the on the screen 44), examples of which are provided below.

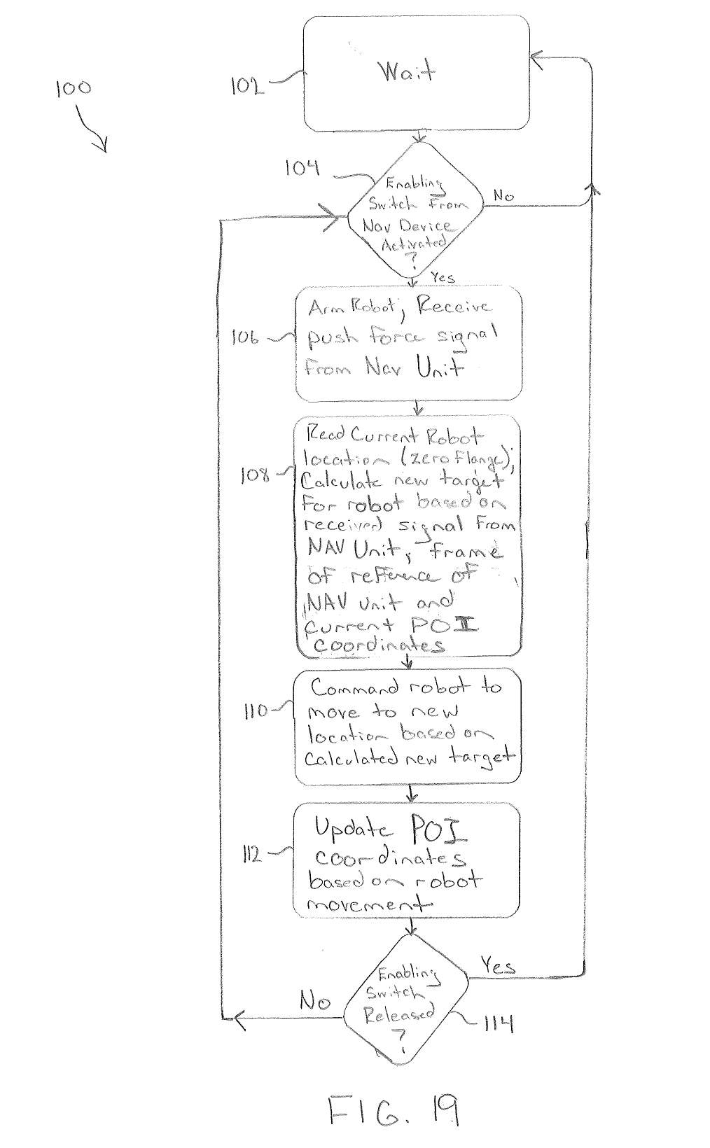

In at least one exemplary embodiment, as shown in the exemplary screen shot of FIG. 17, the user is provided with a number of movement controls including an axis constraint menu 94, a step button 96, and a dominant axis only button 98. The axis constraint menu 94 allows the user to select restrictions for movement. For example, if the user selects “no rotation” on the axis constraint menu, only movements along the X-Y-Z axis of the knob 52 will translate into robotic movement, and any inadvertent roll, pitch or yaw movements suggested by movement of the handheld navigation unit 50 will be ignored. The step button 96 is a toggle button that, when pressed, forces the user to move the knob 52 of the handheld navigation unit 50 for each desired incremental movement of the robot. When this step button 96 is depressed the knob 52 of the handheld navigation unit 50 must be returned to the neutral position before the robot takes another incremental step in the desired direction. When the dominant axis only button 98 is depressed, only movement of the knob 52 along the predominant axis is recognized even though multiple axis are enabled and weaker movements are noted along other axes.

In at least one exemplary embodiment shown in FIG. 18, the user may define various actions for buttons on the handheld navigation unit 50. For example, the handheld navigation unit 50 may include a left button and a right button (illustrated in FIG. 18 by reference numerals 57 and 59). The user may create custom actions for the buttons 57 and 59 or select an action from a list of actions in box 95. One action may be placed in box 97 for the left button 57, and one action may be placed in box 99 for the right button. These buttons then provide further control for the user of the handheld navigation unit 50. In at least one embodiment the actions provided for the buttons 57 and 59 relate to control of a robotic grip or control of a robotic tool.

In one exemplary embodiment, the robotic navigation system 40 may include a number of additional buttons in the form of jog buttons. The jog buttons may include buttons identified as + and − for each of the six control axes. The user may press one or more of these buttons to create movement of the robot using the buttons in lieu of movement of the knob 52.

Flowchart for Robotic Navigation Method

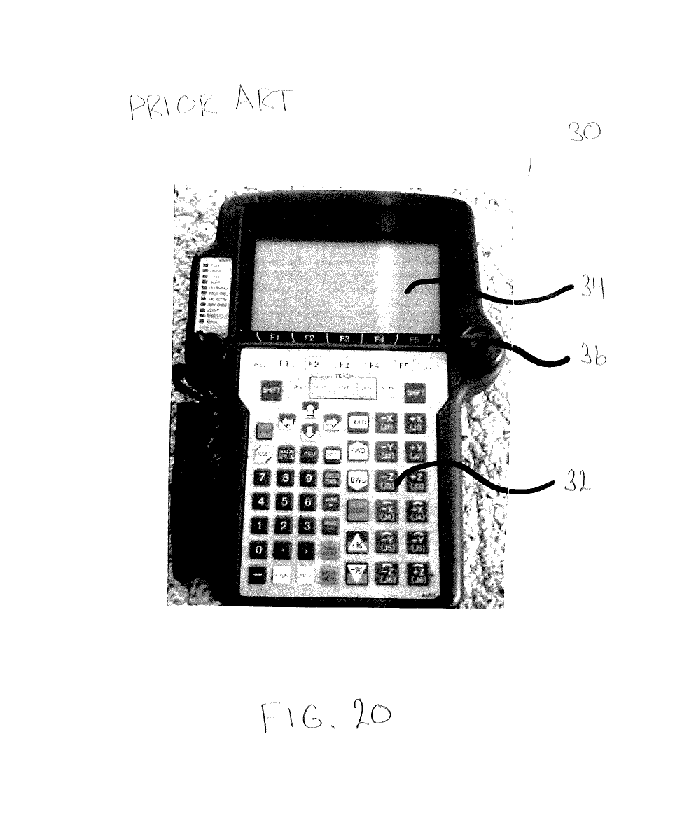

With respect to FIG. 19, a method 100 of operating a robot using the robotic navigation system 40 is shown. According to the method, the electronic control unit 42 waits for a signal from the handheld navigation device 50 in step 102. Then, in step 104, a determination is made whether the safety enabling switch for the handheld navigation unit 50 has been enabled. If the safety enabling switch has not been enabled by the user, the method returns to step 102 and waits for another signal. However if the enabling switch has been enabled by the user, the electronic control unit 42 arms the robot in step 106 and receives the push force signal from the handheld navigation unit 50. As described previously, this push force signal is generally a multi-axis vector that includes a linear movement component, a rotational component, and a speed component. The electronic control unit 42 may manipulate this multi-axis vector by forcing to zero the axis that are disabled according to the motion settings (e.g., for purposes of maintaining a plane, or other limitations). The electronic control unit 42 may also multiply the vector by the speed setting to obtain an appropriate control signal based on the user input and the current settings of the robotic navigation system 40.

With continued reference to FIG. 19, after receiving and manipulating the signal from the handheld navigation unit 50 in step 106, the method moves to step 108 and the electronic control unit 42 reads the current robot location. This location is typically the mounting flange location (e.g., a zero flange location) within a current frame of reference. The electronic control unit 42 then calculates a new target position for the robot (e.g., a new zero flange location) based on the received and manipulated signal from the handheld navigation unit 50, the frame of reference for the handheld navigation unit 50, and any current point of interest coordinates. As discussed previously, the frame of reference and point of interest coordinates (e.g. tool coordinates) will vary depending on the mode of operation for the robotic navigation system 40. Calculation of a new target position thus includes translating the vector received from the handheld navigation unit into a robot motion vector. This may include the use of transforms for tool coordinates. As discussed previously, the use of tool coordinates forces rotation to be centered about the point of interest, instead of simply the end of the robot (i.e., the mounting flange).

Next, in step 110, the method continues by commanding the robot to move to the calculated new location based on the calculated new target. This action may generally include transmitting (e.g., via wired or wireless connection to the robot) the calculated motion vector to the robot, taking into account the current and previous position of the robot. When the robot moves, the handheld navigation unit may relax (or return to a neutral position) as the robot position catches up to the request.

Thereafter, in step 112, the electronic control unit 42 updates the point of interest coordinates (e.g., the tool coordinates) based on movement of the robot. It will be recognized that this updating of the point of interest coordinates typically occurs only in the fixed tool mode, described above with reference to FIGS. 12, 15 and 16. In the world coordinates mode (described above with respect to FIG. 10) and the tool coordinates mode (described above with respect to FIG. 11), the point of interest coordinates are either not used or are fixed in relation to the mounting flange 18. Accordingly, there is no need to update the point of interest coordinates in the world coordinates mode and the tool coordinates mode.

In step 114, the electronic control system determines whether the enabling switch has been released. If the enabling switch has been released, the method returns to step 102 and waits for another control signal from the handheld navigation unit. If the enabling switch has not been released, the method returns to step 104, and the process is repeated, including receiving the next push force signal, moving the robot, and updating point of interest coordinates.

The foregoing detailed description of one or more exemplary embodiments of the robotic navigation device and system has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

What is claimed is:

1. A robotic navigation system configured to move a robot, the robotic navigation system comprising:
a handheld navigation unit associated with a frame of reference, the handheld navigation unit moveable with respect to a plurality of axes, the handheld navigation unit configured to send movement signals based on movement of the handheld navigation unit; and
a controller configured to receive the movement signals from the handheld navigation unit and determine control signals for the robot, the control signals configured to incrementally move the robot with respect to a point of interest removed from the robot, the point of interest removed from a fixed point on the robot as defined by assigned coordinates, the controller configured to reassign the assigned coordinates following each incremental movement of the robot.

2. The robotic navigation system of claim 1 wherein the fixed point on the robot is located on a mounting flange of the robot.

3. The robotic navigation system of claim 1 wherein the point of interest is located on a stationary tool.

4. The robotic navigation system of claim 3 wherein the frame of reference associated with the handheld navigation unit is defined by the stationary tool.

5. The robotic navigation system of claim 1 wherein the frame of reference associated with the handheld navigation unit is defined by a portion of the robot including the fixed point on the robot.

6. The robotic navigation system of claim 1 wherein movement of the handheld navigation unit in one direction with respect to a given axis results in movement of the fixed point on the robot in a related direction.

7. The robotic navigation system of claim 1 wherein the handheld navigation unit includes a mount configured to engage any one of a plurality of mounting features positioned at a plurality of locations on the robot or in proximity of the robot.

8. The robotic navigation system of claim 7 wherein the plurality of mounting features include magnets configured to engage a magnet of opposite polarity on the handheld navigation unit.

9. The robotic navigation system of claim 7 wherein the plurality of mounting features includes unique identifiers.

10. The robotic navigation system of claim 9 wherein the unique identifiers are selected from one of RFID tags, barcodes, QR codes, and resistors.

11. The robotic navigation system of claim 1 wherein the controller is configured to operate in one of a world coordinate mode, a tool coordinate mode, or a remote tool mode, the frame of reference in the world coordinate mode associated with a point on a base of the robot, the frame of reference in the tool coordinate mode associated with a point on a mounting flange of the robot, and the frame of reference in the remote tool mode based on a point on a stationary tool.

12. The robotic navigation system of claim 1 wherein the controller is part of a mobile computer.

13. The robotic navigation system of claim 12 wherein the mobile computer includes a seat for the handheld navigation unit.

14. A robotic system comprising:
a robot including an arm and a mounting flange, the mounting flange moveable with respect to a point of interest, the point of interest defined by a set of assigned coordinates relative to a point on the robot;
a handheld navigation unit positioned on the robot and associated with a frame of reference, the handheld navigation unit moveable with respect to a plurality of axes, the handheld navigation unit configured to send movement signals based on movement of the handheld navigation unit; and
a controller configured to receive the movement signals from the handheld navigation unit, determine a current robot location, calculate a target location for the robot, transmit robot control signals configured to move the robot, and reassign the set of assigned coordinates based on movement of the robot.

15. The robotic system of claim 14 further comprising at least one mounting member positioned on the arm of the robot, the handheld navigation unit mounted on the mounting member.

16. The robotic system of claim 14 wherein the handheld navigation unit is positioned at a location removed from the robot.

17. The robotic system of claim 14 wherein the point of interest is a point on a stationary tool.

18. The robotic system of claim 14 wherein the robot is an articulating robot.

19. A method of controlling a robot comprising:
receiving movement signals from a handheld navigation unit;
determining a current robot location;
calculating a target location for the robot relative to a current point of interest, the current point of interest defined by assigned coordinates relative to a zero coordinate on the robot;
transmitting robot control signals configured to move the robot; and
reassign the assigned coordinates based on movement of the robot.
